(19) United States
(12) Patent Application Publication
(10) Pub. No.: US 2004/0123279 A1
(43) Pub. Date: Jun. 24, 2004

(54) Method and system for auto-instrumenting java applications through probe injection

(75) Inventors: James Russell Boykin, Pflugerville, TX (US); Alberto Giammaria, Austin, TX (US); Brian Joseph Schlosser, Austin, TX (US); Kevin Gary Tapperson, Austin, TX (US)

Correspondence Address: Joseph R. Burwell, Law Office of Joseph R. Burwell, P.O. Box 28022, Austin, TX, 78755-8022, US

(73) Assignee: INTERNATIONAL BUSINESS MACHINES CORPORATION, ARMONK, NY

(21) Appl. No.: 10/324,360

(22) Filed: Dec. 18, 2002

(51) Int. Cl. G06F 9/45; G06F 9/46

(52) U.S. Cl. 717/158; 719/328

(57) ABSTRACT

A technique is presented for instrumenting a Java application in a just-in-time fashion. A software developer obtains Java class files that comprise an application that the software developer desires to instrument. The software developer also obtains code for instrumentation probes; each probe is associated with a location in an application, e.g., a specific method within a specific class. The probes along with the associated locations are registered in a registry, either programmatically or by loading a configuration file. At class load time, an injector determines whether a loaded class has any instrumentation locations as predetermined by information in the registry. If so, the injector inserts hooks in the loaded class. When the hooks are executed, the hooks can manage the execution of the probes, which can be dynamically added or removed from the registry during runtime and/or dynamically enabled or disabled during runtime.

### BACKGROUND OF THE INVENTION

1. Field of the Invention

The present invention relates to an improved data processing system and, in particular, to a method and apparatus for performing system management in a data processing system. Still more particularly, the present invention provides a method and apparatus for a software program development tool for managing the operation of software applications through software instrumentation.

2. Description of Related Art

Software developers would often like to instrument a particular Java application for various purposes. Typically, however, the software developer only has access to the Java class files and not to the source code, which makes it difficult to insert instrumentation code into the application.

There is a large set of system management utilities that are designed to manage characteristics of other applications: maintenance, performance, workload, serviceability, license usage, and other characteristics. These utilities require the managed application to be instrumented with system management application programming interfaces (APIs) in order to be operable; for example, the Logging Toolkit for Java (JLog) provides features to enhance the reliability of Java applets and applications; JLog includes message logging, tracing functions, and a Log Manager, which configures the various logging objects. The problem is that few applications have been instrumented with these APIs prior to being deployed, particularly with respect to production versions of the applications, which lowers the value of these management tools.

Therefore, it would be advantageous to allow a developer to automatically instrument a Java application by injecting system management APIs or other types of APIs into the Java application classes even though the developer does not have access to source code for the application that the developer wants to instrument.

### SUMMARY OF THE INVENTION

A technique is presented for instrumenting a Java application in a just-in-time fashion. A software developer obtains Java class files that comprise an application that the software developer desires to instrument. The software developer also obtains or writes code for instrumentation probes; each probe is associated with a location in an application, e.g., a specific method within a specific class. The probes along with the associated locations are registered in a registry, either programmatically or by loading a configuration file. At class load time, an injector determines whether a loaded class has any instrumentation locations as predetermined by information in the registry. If so, the injector inserts hooks in the loaded class. When the hooks are executed, the hooks can manage the execution of the probes, which can be dynamically added or removed from the registry during runtime and/or dynamically enabled or disabled during runtime.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical network of data processing systems, each of which may implement the present invention;

FIG. 1B depicts a typical computer architecture that may be used within a data processing system in which the present invention may be implemented;

FIG. 2 depicts a block diagram that shows an overview of some of the data flow that occurs within a system that supports the software instrumentation operations of the present invention;

FIG. 3 depicts a model diagram that shows a set of logical relationships between data items that are related to probes;

FIGS. 4A-4B depict a pair of block diagrams that show an exemplary configuration of runtime components along with their interaction with a probe registry;

FIG. 5 depicts a simple temporal diagram that shows three main phases in the just-in-time instrumentation functionality of the present invention;

FIG. 6 depicts a flowchart that shows a process for a probe specification phase for the just-in-time instrumentation functionality of the present invention;

FIG. 7 depicts a flowchart that shows a process for a probe injection phase for the just-in-time instrumentation;

FIG. 8 depicts a flowchart that shows a simplified process for a probe runtime phase for the just-in-time instrumentation;

FIGS. 9-10 depict a pair of flowcharts that shows a first version of an injection mechanism that may be used during a probe injection phase of the just-in-time instrumentation functionality of the present invention;

FIGS. 11A-11B depicts a control flow diagram that shows some of the method calls and returns that occur while using the injection mechanism that is illustrated in FIGS. 9-10; and

FIG. 12 depicts a flowchart that shows a second version of an injection mechanism that may be used during a probe injection phase of the just-in-time instrumentation functionality of the present invention.

### DETAILED DESCRIPTION OF THE INVENTION

In general, the devices that may comprise or relate to the present invention include a wide variety of data processing technology. Therefore, as background, a typical organization of hardware and software components within a distributed data processing system is described prior to describing the present invention in more detail.

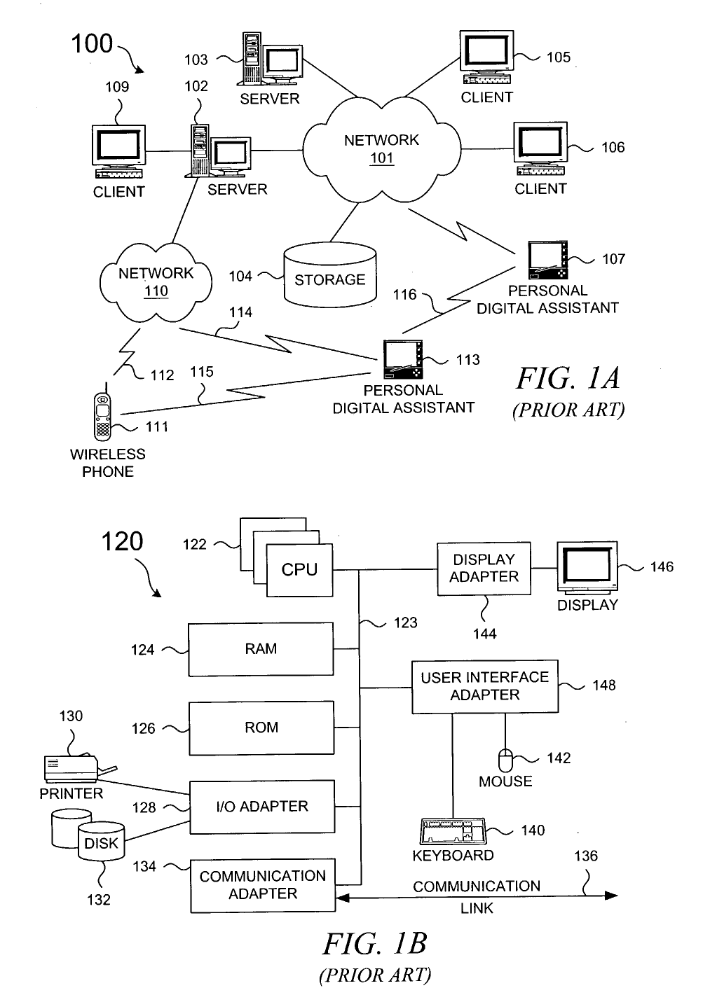

With reference now to the figures, FIG. 1A depicts a typical network of data processing systems, each of which may implement the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as LDAP (Lightweight Directory Access Protocol), TCP/IP (Transport Control Protocol/Internet Protocol), HTTP (HyperText Transport Protocol), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks or personal ad-hoc networks. In a similar manner, PDA 113 can transfer data to PDA 107 via wireless communication link 116.

The present invention could be implemented on a variety of hardware platforms and software environments. FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, extensible Markup Language (XML), HyperText Markup Language (HTML), Handheld Device Markup Language (HDML), Wireless Markup Language (WML), and various other formats and types of files. It should also be noted that the distributed data processing system shown in FIG. 1A is contemplated as being fully able to support a variety of peer-to-peer subnets and peer-to-peer services.

A preferred embodiment of the present invention is configured to operate in conjunction with Java applications and their associated runtime environments, but the present invention may be implemented in similar environments that provide the required functionality.

The Java language is an object-oriented programming language that is compiled to run on any Java Virtual Machine (JVM). Hence, as long as a given hardware device and its associated operating system support a version of a JVM, a Java application can be executed on a computer system with support from the JVM. Java programs are compiled into bytecode, which will run on any JVM. The JVM essentially acts as an interpreter between the Java bytecodes and the system on which the Java program is executing.

There are four major components to a JVM, all of which are implemented in software. The four components are the registers, the operand stack, the garbage collected heap, and the method area. The method area contains the method code, i.e. the compiled Java code, and symbol tables. The compiled Java code, i.e. the bytecode, consists of a set of instructions. Each instruction consists of a one byte opcode followed by any needed operands. Compiled Java programs are typically referred to as Java class files. Many Java class files are downloaded from the Internet for execution on a user's computer system; hence, the application source code is not available to a software engineer that desires to instrument an application.

One of the first steps performed by a JVM when executing an application is called verification. A class file verifier, which is part of the JVM, ensures that the file truly is a Java class file and will execute without violating any Java security restrictions. The verifier also checks various sections of the class file for consistency. During the linking phase, the verifier ensures that all classes except for the “Object” class have a superclass and that all field and method references in the constant pool have valid names, classes, and type descriptors. In addition, the verifier checks the code array of the code attribute for each method to ensure that all local variables contain values of the appropriate type, that methods are called with the appropriate arguments, and that fields are assigned correct values. The verifier also checks the operand stack for correctness.

Finally, during execution, the verifier checks to ensure that a referenced type is allowed for instructions referencing a type. If an instruction modifies a field or calls a method, the verifier checks to ensure that the field or method is available and that the calling method is allowed to access the field or call the method. The present invention operates within a standard JVM without disturbing the operations of the JVM's class file verifier.

Given the description of FIGS. 1A-1B as background information, the description of the remaining figures relates to the present invention, which is directed to a method for instrumenting software. More specifically, the present invention allows developers to automatically instrument Java applications by indirectly injecting probe hooks into the class files. Hooks are directly injected into the class files at class-load time, i.e. when the application classes are loaded into memory by the Java Virtual Machine, and the hooks are used to manage the execution of the probes. The application source code is not required for these operations, and application binaries, i.e. jar files, are not modified.

The present invention is similar to just-in-time compilation with respect to its temporal aspects. Just-in-time compilation comprises the technique of compiling source code into machine code (or interpretable bytecodes) at runtime. In a similar temporal fashion, the present invention comprises the technique of injecting probe hooks into code at runtime. Hence, the present invention may be described as providing a technique for just-in-time instrumentation.

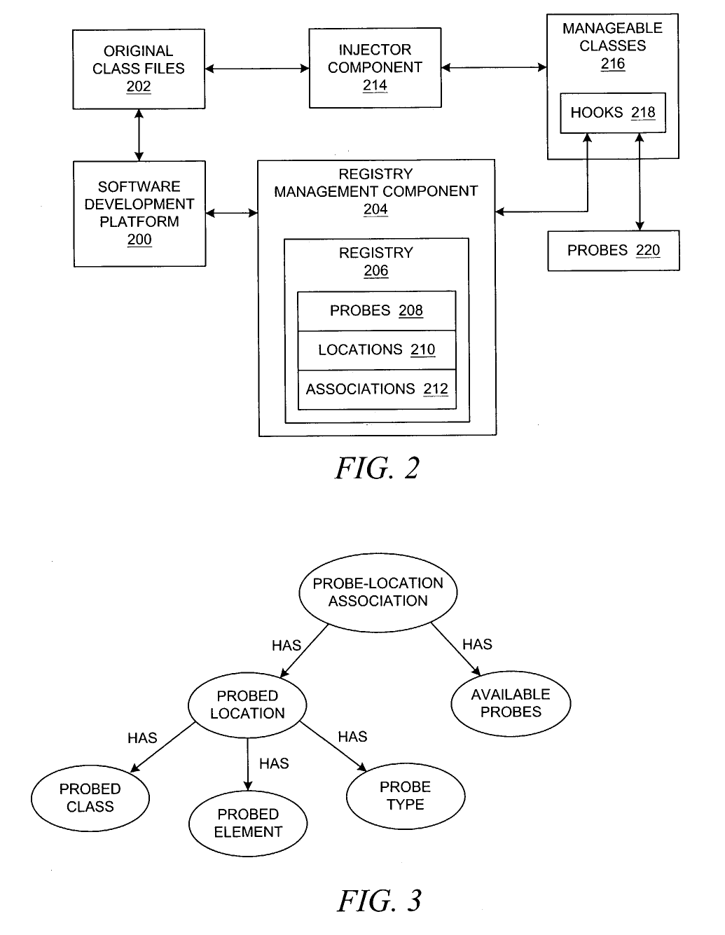

With reference now to FIG. 2, a block diagram depicts an overview of some of the data flow that occurs within a system that supports the software instrumentation operations of the present invention. A software programmer or software engineer uses software development platform 200 to create original class files 202 that comprise a software application. Alternatively, the software engineer obtains class files from some location yet desires the ability to instrument the class files.

In addition, the software engineer controls the creation and management of probes with assistance from registry management component 204, which manages the probes and other information in registry 206. A software engineer specifies probes 208 along with locations 210 and associations 212, which are described in more detail further below.

Injector component 214 retrieves probe location information 210 from registry 206 via application programming interfaces (APIs) that are provided by registry management component 204. Using the probe location information, injector component 214 inserts hooks into original class files 202 at class load time to create manageable classes 216 comprising hooks 218, which read probe information 208 from registry 206 in accordance with an association between the location of a particular hook and one or more probes that are associated with that location. Thereafter, hooks 218 execute probes 220.

In other words, the injector alters the Java methods, constructors, or other elements specified in the registry by injecting special bytecodes into the class files. These bytecodes include invocations to hooks methods that contain the logic to manage the execution of the probes. When a hook is executed, it gets the list of probes that are currently enabled for its location from the registry and executes them.

Registry management component 204 may comprise classes, modules, objects, libraries, or other software entities that convey functionality for managing probes. Depending upon the implementation of the system, this functionality may be incorporated into the software development platform such that a software engineer can use a probe management utility to generate and manage probes during application development. In this scenario, the probes might be used to gather information that assists the software engineer in enhancing application performance. In an alternative embodiment, a software maintenance engineer may use a different type of application that incorporates the functionality of the registry management component to manage the probes for software maintenance purposes, such as to gather usage information about an application. Hence, the specific form of the components that comprise probe-related functionality may vary depending upon the use of the present invention.

With reference now to FIG. 3, a model diagram depicts a set of logical relationships between data items that are related to probes. As shown in FIG. 3, a probe location is the combination of a probed class specification, a probed element specification, and a probe type. A probe location specifies one or more probe insertion points in a Java class or a set of Java classes.

An available probe is a probe known to the just-in-time instrumentation functionality. This means that the probe is correctly installed in the probe repository and registered to the registry. Associations relate available probes to locations. An enabled association indicates that the referenced probe (or probes) must execute when the program control flow passes through the referenced location (or locations).

Probes, locations, and associations can be enabled and disabled, including enabling and disabling the probes during runtime. Disabling a probe prevents its subsequent execution. Disabling a location prevents the subsequent execution of all the probes at that location. Disabling an association prevents the subsequent execution of all probes referenced in the association at the association's location.

The registry is the component responsible for storing and managing the status of the following objects: available probes; probed classes; probed methods; probe types; probed locations (represented by probed classes, methods and probe types); and associations between probes and locations. Available probes, probed classes, probed methods, probe types, locations, and associations between probes and associations can be loaded in the registry from an XML file or programmatically through a registry API. New locations, new probes, and any change to the status of registered probes, locations, and associations can take effect immediately. This allows administrators to enable new probes or disable existing probes for already defined locations while applications are executing.

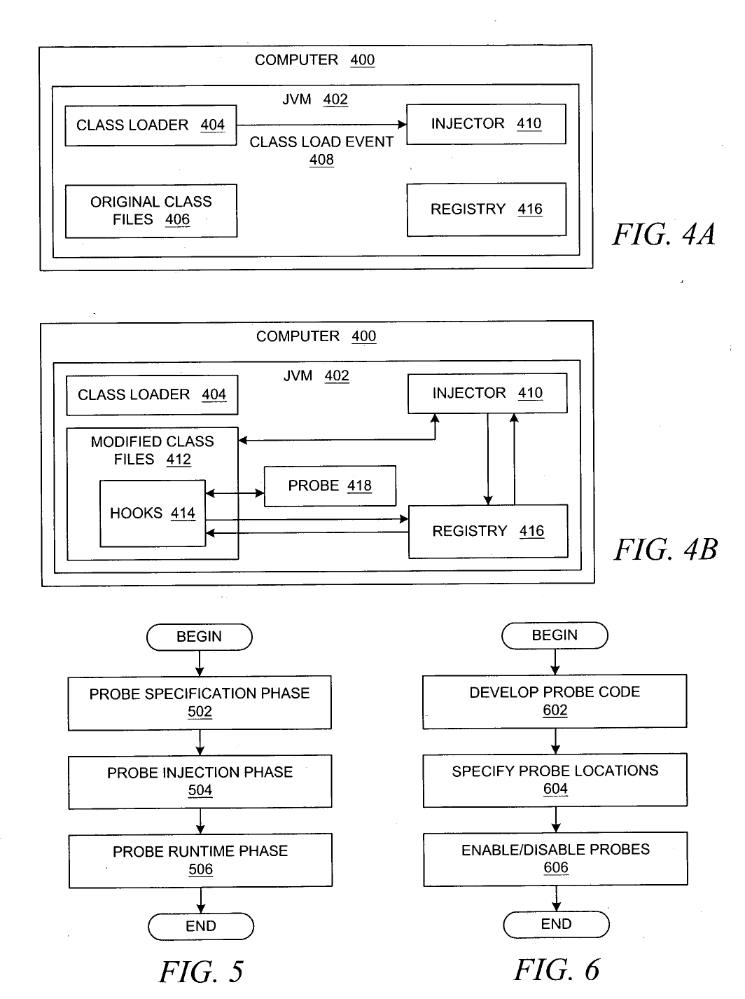

With reference to FIGS. 4A-4B, a pair of block diagrams depicts an exemplary configuration of runtime components along with their interaction with a probe registry. Whereas FIG. 2 depicts some of the flow of data items among functional components, and whereas FIG. 3 depicts logical relationships among those data items, FIG. 4 depicts an exemplary runtime environment that may be used to achieve the just-in-time instrumentation functionality of the present invention. Similar elements in FIG. 4A and in FIG. 4B are referenced using similar reference numerals.

Referring to FIG. 4A, computer 400 supports Java virtual machine 402 that includes class loader 404 for loading Java classes. During the class load process, the class loader provides an indication, e.g., class load event notification 408, to injector 410, which then injects hooks into the classes.

Referring to FIG. 4B, injector 410 has created modified class files 412 by injecting hooks 414 into the original class files; class files 412 are similar to manageable classes 216 that are shown in FIG. 2. Injector 410 can determine whether to inject a hook into a recently loaded class by querying the probe registry 416, e.g., by using an identifier of the recently loaded class, which may be provided to injector 410 through class load event notification 408; probe registry 416 is similar to registry 206 that is shown in FIG. 2. If the registry has at least one location for the recently loaded class, then the injector proceeds to inject or embed at least one hook at an indicated method or constructor. If the registry lacks a location for the recently loaded class, then the injector does not modify the original class file, i.e. no hooks are injected for the recently loaded class. Similarly, when a hook is invoked, the hook can determine whether a probe is enabled for its location by querying the registry, e.g., by providing an identifier for the location in which the hook was embedded. If the registry has an enabled probe, then the hook gets and executes probe 418.

With reference now to FIG. 5, a simple temporal diagram depicts three main phases in the just-in-time instrumentation functionality of the present invention. As is implied in FIG. 2 and FIGS. 4A-4B, the just-in-time instrumentation functionality comprises probe specification phase 502, followed by probe injection phase 504, which is followed by probe runtime phase 506. Each of these phases are described in more detail below with respect to FIGS. 6-8, respectively.

With reference now to FIG. 6, a flowchart depicts a process for a probe specification phase for the just-in-time instrumentation. The process begins with a user, such as a software engineer, developing the software for the probes by developing one or more classes that implement the probe interface (step 602).

The user then specifies within the probe registry the Java elements that need to be instrumented (step 604), i.e. the probe locations. New locations can be defined programmatically through a registry API, or the new locations can be specified by importing an XML-based probe registration file, which is a type of configuration file or definition file. The user then enables/disables one or more probes for each specified probe location (step 606), and the process is complete. Step 606 can be repeatedly performed while the application is executing, i.e. during the probe runtime phase.

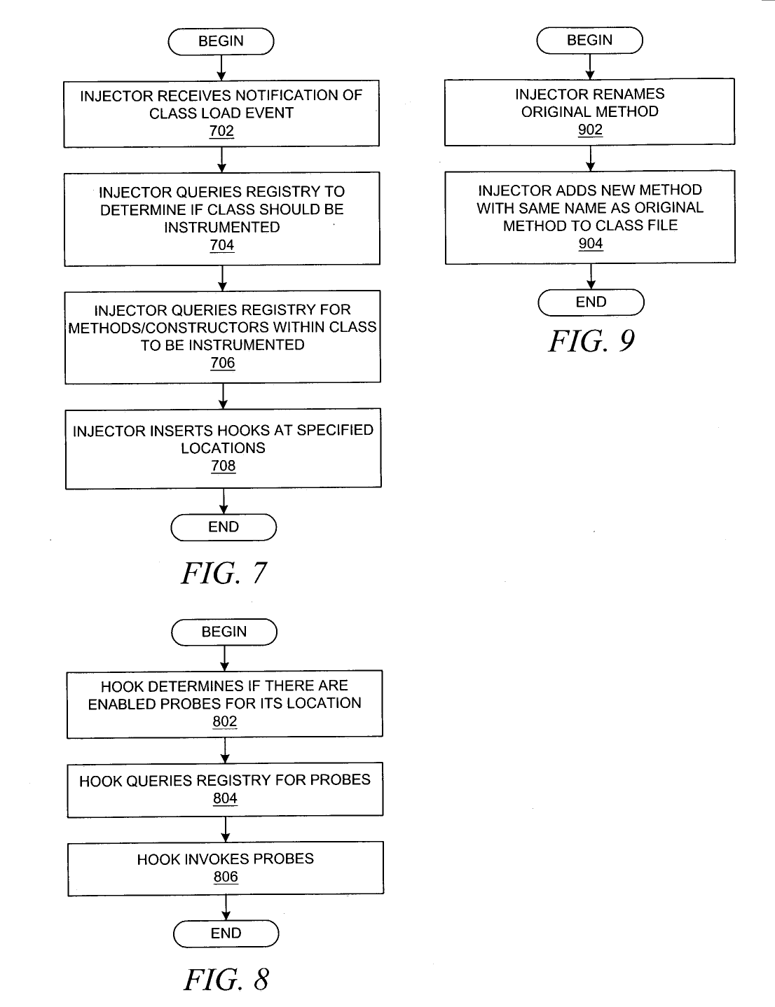

With respect to FIG. 7, a flowchart depicts a process for a probe injection phase for the just-in-time instrumentation functionality of the present invention. At some point in time after a software engineer has completed the probe specification phase, the software engineer will desire to execute an instrumented software application. The task of the injector is to add hooks to the Java methods/constructors specified by the registry. The injector works in conjunction with a class loader hook, e.g., a “JVMPI_EVENT_CLASS_LOAD_HOOK” event, to alter the class byte array before it is loaded into memory. When the injector is notified that a new Java class is being loaded (step 702), it queries the registry to determine whether the newly loaded class needs to be instrumented or not (step 704). Assuming that the class should be instrumented, the injector then queries which methods, constructors, and fields within that class need to be instrumented (step 706). The injector then injects the hooks at the specified locations (step 708), thereby completing the process in the probe injection phase, which would be completed for each loaded class. Two versions of the probe injection phase are described in more detail further below with respect to FIGS. 9, 10, and 12.

Although the examples herein describe probed locations for constructors, methods, and fields, the technique is applicable to catch blocks, throw statements, synchronized blocks, static initializers, method invocations, etc. It is also possible to allow a probe to modify the return value or the exception thrown by a probed method.

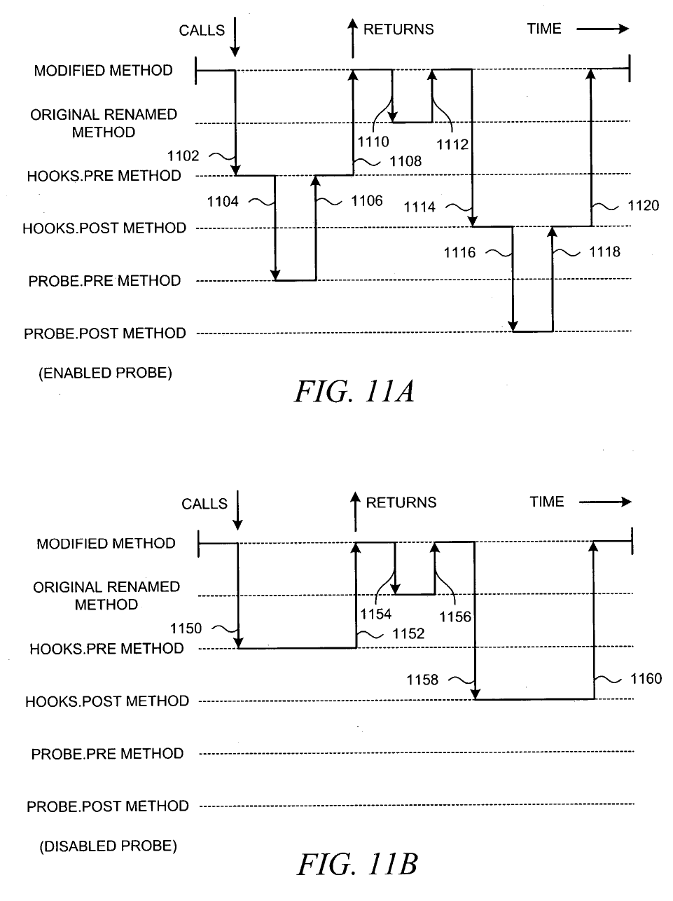

With respect to FIG. 8, a flowchart depicts a simplified process for a probe runtime phase for the just-in-time instrumentation functionality of the present invention. The process begins with a hook being executed in the course of the execution of the instrumented application. The hook determines if there are enabled probes for the hook's location (step 802). Assuming that there is at least one enabled probe, the hook queries the registry for the probes (step 804). The hook then executes the probes (step 806), and the probe runtime process is complete. Two examples of the control flow that may occur during the probe runtime phase are described below with respect to FIGS. 11A-11B.

Prior to providing some examples of pseudocode for the probe injection phase and the probe runtime phase, an example of a probe registration file and some examples of programmatic declarations are shown in support of the examples of pseudocode.

An example of a probe registration file that contains probes, locations, and associations is shown in Table 1. Probed classes can be specified individually or through filters, such as specifying all classes that directly extend class “HttpServlet” or specifying all classes in package “com.ibm.websphere” that directly implement the “SessionBean” interface. In a manner similar to classes, probed methods can be specified individually or through filters, such as all “public” methods or all methods with parameter list “(byte[ ], int, int)”.

TABLE 1
<registry xmlns=“http://www.ibm.com/jiti”

xmlns:xsi=“http://www.w3.org/2001/XMLSchema-instance”
xsi:schemaLocation=“http://www.ibm.com/jiti registry.xsd”>
<!- simple class -->
<class id=“SocketIS”

description = “The SocketInputStream class”>
name=“com.ibm.net.SocketInputStream”/>

<!- class wildcard at the beginning -->
<class id=“AllClassesThatEndWithServlet”>

name=“*Servlet”/>

<!- class with super class -->
<class id=“AllClassesDirectlyExtendingFromHttpServlet”>

name=“*”>

<extends name=“javax.servlet.http.HttpServlet”/>
</class>
<!- class with interfaces -->
<class id=“AllClassesDirectlyImplementingSessionBean”>

name=“*”>

```
    <implements name=“javax.ejb.SessionBean”/>
</class>
<!- with super class and interfaces -->
<class id=“AllTivoliSessionBeansExtendingAGSessionBean”>
    name=“com.ibm.tivoli.*”>
    <extends>com.ibm.tivoli.AGSessionBean</extends>
    </isAssignableTo name=“javax.ejb.SessionBean”/>
</class>
<!- simple method -->
<method id=“IOSClose”
```

description=“the I/O stream close method”>
name=“close”/>

<!- all methods -->
<method id=“allMethods”>

name=“*”/>

<!- method with modifiers -->
<method id=“AllPublicStaticMethods”>

name=“*”>

```
    <modifier name=“public”/>
    <modifier name=“static”/>
</method>
<!- method with specific parameters -->
<method id=“ISRead”>
```

name=“read”>
parameters=“(byte[], int, int)”/ >

<!- all methods with no parameters -->
<method id=“allMethodsWithEmptyParam”>

name=“*”
parameters=“( )”/ >

<!- probe that require parameters -->
<probe id=“TransferRateProbe”

class=“com.ibm.sysmgmt.probe.TransferRateProbe”
requiresParameters=“true”/>

<!- disabled probe -->
<probe id=“JLogProbe”

class=“com.ibm.sysmgmt.probe.JLogProbe”
disabled=“true”/>

<!- simple location -->
<location id=“SimpleLocation”>

<class ref=“SocketIS”/>
<method ref=“allMethods”/>
<type ref=“methodBodyType”/>

</location>
<!- disabled location -->
<location id=“DisabledLocation” disabled=“true”>

<class ref=“SocketIS”/>
<method ref=“ISRead”/>
<type ref=“methodBodyType”/>

</location>
<!- association -->
<association id=“SimpleAssociation”>

<location ref=“SimpleLocation”/>
<probe ref=“TransferRateProbe”/>

</association>
<!- disabled assocation -->
<association id=“DisabledAssociation” disabled=“true”>

<location ref=“SimpleLocation”/>
<probe ref=“JLogProbe”/>

</association>

</registry>

Probes may be divided into the following types: constructor probes, field probes, and method probes. Constructor and method probes allow developers to add code to an existing Java constructor or method at the following points: before it executes, after it successfully executes, and/or after it completes throwing an exception. Field probes allow developers to add code after getting or setting a Java field, i.e. with respect to getter/setter functions.

A constructor probe is any Java class that implements a special constructor probe interface, while a method probe is any Java class that implements a special method probe interface; Table 2 provides examples of those interfaces. A field probe is any Java class that implements a special field probe interface.

TABLE 2

public interface IConstructorProbe {

/** Called before an execution of a probed constructor but

after the super call */

public void pre(IConstructorProbeContext context);
/** Called after a successful execution of a probed

constructor */

public void post (IConstructorProbeContext context);
/** Called after an execution of a probed constructor that

threw an exception */

public void postThrown(IConstructorProbeContext context);

}
public interface IMethodProbe {

/** Called before an execution of a probed method */
public void pre(IMethodProbeContext context);
/** Called after successful execution of probed method */
public void post(IMethodProbeContext context);
/** Called after execution of probed method that threw an

exception */

public void postThrown(IMethodProbeContext context);

}
public interface IFieldProbe {

/* Called after a probed field is assigned */
public void postSet(IFieldProbeContext context);
/** Called after a probed field is accessed */
public void postGet(IFieldProbeContext context);

}

The execution context of the probes (probed object, method/constructor signature, parameters, return value, or other data items) is passed through a “context” parameter, as illustrated in Table 3.

TABLE 3
public interface IInvokedMemberContext {

/** Provides information about invoked method or

constructor */

/** Return the class being probed */
public Class getProbedClass( );
/** Return the object being probed. Null for static

methods and constructors */

public Object getProbedObject( );
/** Return the method/constructor being probed */
public Member getProbedMember( );
/** Return parameters of method/constructor being probed*/
public Object[] getProbedParameters( );

}
public interface IProbeContext {

/** Represents common elements of all probe types */
/** Return the invoked method of constructor */
public IInvokedMemberContext getInvokedMemberContext( );
/** Developers can pass additional information from the

“pre” method to the others through the methods “setUserObject”
or “getUserobject */

/** Set a user object in this probe context */
public void setUserObject(Object userObject);
/** Return the object set with “setUserObject” */
public void getUserObject(Object userObject);

}
public interface IMethodProbeContext extends IProbeContext {

/** Return the probed method */
public Method getProbedMethod( );
/** Return the return value of the probed method */
public Object get ProbedReturnValue( );
/** Return exeception thrown by the probed method */
public Throwable getProbedThrowable( );

}
public interface IConstructorProbeContext extends IProbecontext {

/** Return the probed constructor */
public Constructor getProbedConstructor( );
/** Return exception thrown by probed constructor */
public Throwable getProbedThrowable( );

}
public interface IFieldProbeContext extends IProbeContext {

/** Return the probed class which contains the field being

retrieved or set */

public Class getProbedFieldClass( );
/** Return the probed object which contains the field being

retrieved or set */

public Object getProbedFieldObject( );
/** Return the probed field being retrieved or set */
public Field getProbedField( );
/** Return the old value of the probed field prior to an

assignment statement */

public Object getProbedFieldOldValue( );
/** Return the current value of the probed field */
public Object getProbedFieldValue( );

}

Hooks are implementations of the “IHooks” interface in which “IProbeHandle” is an opaque object that is returned by the “pre” methods and passed as first parameter to the “post” and “postThrown” methods, as illustrated in Table 4.

TABLE 4
public interface IHooks {

public IInvokedMemberContext

createInvokedMemberContext(Class objectClass, String methodName,
String methodDescriptor, in methodModifiers, Object object,
Object [] parameters);

public IProbeHandle pre(IInvokedMemberContext

memberContext);

public void post(TProbeHandle handle, Object returnValue);
public void postThrown(IProbeHandle handle, Throwable

exception);
}
public interface IProbeHandle {

public interface Entry {

public Object getProbe( );
public IProbeContext getProbeContext( );

}
Entry[] getEntries( );
void setEntries(Entry[] entries);

}

Pseudocode examples for a “Hooks.pre” method and a “Hooks.post” method for method probes are illustrated in Table 5 and Table 6, respectively. Similar code would be required for constructor probes, fields probes, etc.

TABLE 5

```
IProbeHandle pre(IInvokedMemberContext memberContext) {
  IProbeHandle handle = factory.newProbeHandle( );
  handle.setEntries(registry.getProbes(memberContext));
  IProbeHandle.Entry[] entries = handle.getEntries( );
  for (int i = 0; i < entries.length; i++) {
```

MethodProbe probe = (MethodProbe) entries[i]. getProbe( );
ProbeContext probeContext = entries[i].getProbeContext( );
try {

probe.pre(probeContext);

} catch(Throwable t) {

log ... // trace problem with this probe

}

```
  }
  return handle;
}
```

TABLE 6

```
void post(IProbeHandle handle, Object returnValue) {
  IProbeHandle.Entry[] entries = handle.getEntries( );
  for (int i = 0; i < entries.length; i++) {
```

MethodProbe probe = (MethodProbe) entries[i].getProbe( );
ProbeContext probeContext = entries[i].getProbeContext( );
probeContext.setReturnValue(returnValue);
try {

probe.post(probeContext);

} catch(Throwable t) {

log ... // trace problem with this probe

}

}
}

An example of a registry API is illustrated in Table 7.

TABLE 7
public interface IRegistry {

//Probe methods
public IProbeSpec createprobe(String probeID, String

description, String probeClass, Boolean requireParameters);

public void removeProbe(String probeId);
public IProbeSpec getProbe(String probeID);
public IProbeSpec[] getProbes( );
public void enableProbe(String probeID, boolean enabled);
//Class methods
public IClassSpec createClass(String classID, String

description, String className, String superClassName, String[]
interfaceNames);

public void removeClass(String classID);
public IClassSpec getClass(String classID);
public IClassSpec[] getClasses( );
//Method methods
public IMethodSpec createMethod(String methodID, String

description, String methodName, String methodDescriptor, int
methodAccess);

public void removeMethod(String methodID);
public IMethodSpec getMethod(String methodID);
public IMethodSpec[] getMethods( );
//Location methods
public ILocationSpec createLocation(String LocationID,

String description, String classID, String methodID);

public void removeLocation(String locationID);
public ILocationSpec getLocation(String locationID);
public ILocationSpec[] getLocations( );
public void enableLocation(String locationID, boolean

enabled);

//Association methods
public IAssociation createAssociation(String

associationID, String locationID, String[] probeIDs);

public void removeAssociation(String associationID);
public IAssociation getAssociation(String associationID);
public IAssociation[] getAssociations( );
public void enableAssociation(String associationID,

boolean enabled);

//Used by the Injector
public IProbeTypeSpec[] getProbeTypesForLocation(String

classToProbe, Class superClass, Class interfaces[], String
methodName, int methodAccess, String methodDescriptor);

//Used by the runtime
String[] getConstructorProbeClassNames(String

classToProbe, int constructorModifier, String
constructorDescriptor);

String[] getMethodProbeClassNames(String classToProbe,

String methodName, int methodModifier, String methodDescriptor);
}

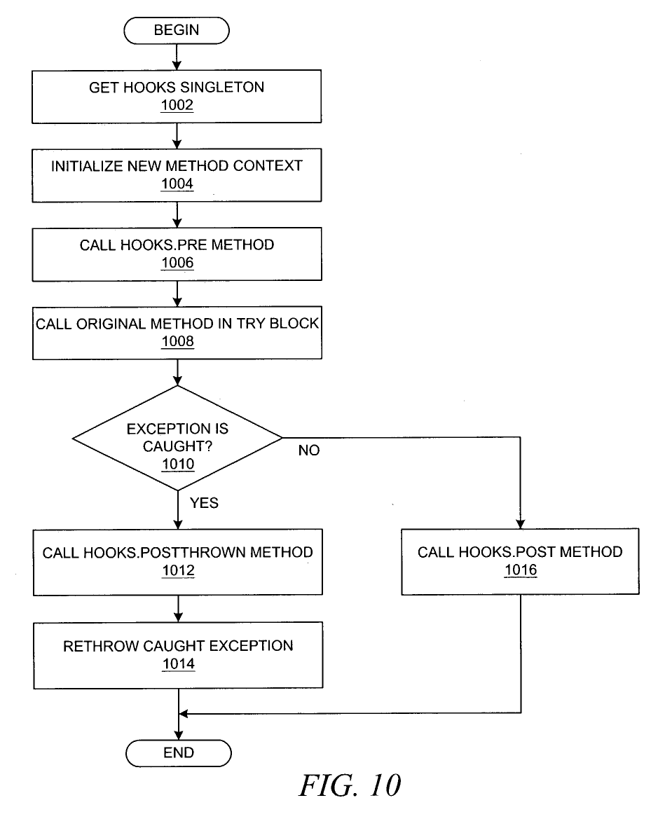

With reference now to FIGS. 9-10, a pair of flowcharts depicts a first injection mechanism that may be used during a probe injection phase of the just-in-time instrumentation functionality of the present invention. The first injection mechanism that is shown in FIGS. 9-10 is a non-intrusive injection. In this first injection mechanism, the original method of the class is renamed and remains completely intact. The injector creates a new method in the class with the same name and signature as the original method. The code for the new method is generated dynamically by the injector, and the new method invokes the original renamed method. The code for the new method also contains the code to invoke the appropriate methods in the “Hooks” runtime at the appropriate times.

This first injection mechanism can be used to insert calls to the “Hooks” runtime for method probes into class files. However, this first injection mechanism cannot be used to insert calls to the “Hooks” runtime for constructor probes due to the requirements of the JVM specification, which is promulgated by Sun Microsystems, Inc. The JVM specification states that before a constructor invokes another constructor within the same class or a constructor of its super class, the only operation that a constructor can perform on the “this” object is assigning fields declared within the class. This means that a constructor cannot be wrapped in the manner described with respect to this first injection mechanism because the “this” pointer for the uninitialized object that is being constructed would be passed to a non-constructor method before it was fully initialized.

Referring to FIG. 9, the first injection mechanism begins by renaming an original version of a method (step 902) and then adding a new method with the same name as the original version of the method to the method's class file (step 904), thereby completing the process.

Referring to FIG. 10, the new method that is added at step 904 is generated such that it performs the following steps. The method gets the “Hooks” singleton (step 1002) and initializes a new “InvokedMemberContext” (step 1004). The method then calls the “Hooks.pre” method (step 1006) followed by a call to the original method in a try block (step 1008). If an exception is caught (step 1010), the method calls the “Hooks.postThrown” method in the corresponding catch block (step 1012) and re-throws an exception that was thrown by the original method (step 1014). If no exception is caught and rethrown at step 1010, the method then calls the “Hooks.post” method (step 1016). In either case, the process is complete.

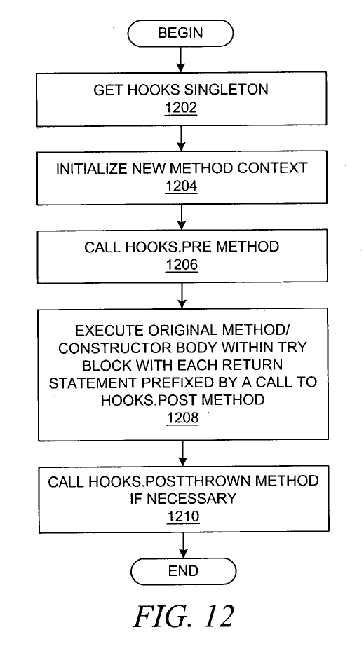

This first injection mechanism is the fastest approach to inject hooks in a method because it does not require scanning each bytecode in a Java method. Unfortunately, this injection mechanism requires a slightly larger class file compared with the second injection mechanism that is described further below with respect to FIG. 12.

With reference now to FIGS. 11A-11B, a control flow diagram depicts some of the method calls and returns that occur during the probe runtime phase using the first probe injection mechanism that is illustrated in FIGS. 9-10. The time periods that are shown in FIGS. 11A-11B are not drawn to scale and may vary. Referring to FIG. 11A, at some point in time, the method that was generated by the injector, i.e. the modified version of an original method, is invoked. Control flow eventually reaches the “Hooks.pre” method within the executing method, which is then invoked (step 1102). The “Hooks.pre” method determines whether there is an enabled probe, and if so, it obtains and calls the appropriate “Probe.pre” method (step 1104). Eventually, the “Probe.pre” method returns to the “Hooks.pre” method (step 1106), which eventually returns to the modified method (step 1108).

Control flow then reaches the call to the original renamed method, which is invoked (step 1110), and after it finishes executing, it returns to the modified method (step 1112). Assuming that no exceptions were thrown, control flow then reaches the “Hooks.post” method, which is invoked (step 1114), and the “Hooks.post” method calls the “Probe.post” method (step 1116). After the “Probe.post” method returns (step 1118), the “Hooks.post” method eventually returns to the modified method (step 1120).

In contrast to FIG. 11A, FIG. 11B shows an instance of an instrumented method for which there are no enabled probes, thereby illustrating the manner in which a combination of hooks and probes in the present invention can be used to dynamically control the operational characteristics of the probes within an instrumented application. Referring to FIG. 11B, at some point in time, the method that was generated by the injector, i.e. the modified version of an original method, is invoked. Control flow eventually reaches the “Hooks.pre” method within the executing method, which is then invoked (step 1150). The “Hooks.pre” method determines whether there is an enabled probe. In this example, since there are no enabled probes at this particular location, the “Hooks.pre” method returns to the modified method (step 1152).

Control flow then reaches the call to the original renamed method, which is invoked (step 1154), and after it finishes executing, it returns to the modified method (step 1156). Assuming that no exceptions were thrown, control flow then reaches the “Hooks.post” method, which is invoked (step 1158). Again, since there are no enabled probes at this particular location, the “Hooks.post” method returns to the modified method (step 1160).

With reference now to FIG. 12, a flowchart depicts a second injection mechanism that may be used during a probe injection phase of the just-in-time instrumentation functionality of the present invention. The second injection mechanism that is shown in FIG. 12 is a more intrusive mechanism than the first injection mechanism that was described above with respect to FIGS. 9-10. In this second injection mechanism, the injector works directly with the original code of the method that it is modifying to insert calls to the “Hooks” runtime in the appropriate places. This second injection mechanism can be used for all probe types, including those that can be injected using the first non-intrusive injection mechanism. The second intrusive injection mechanism inserts code at the beginning of the method (or immediately following the “super( )” or “this( )” call in the case of a constructor) to setup the “Hooks” runtime. The injector then searches the original code for certain instructions and inserts code immediately before or after those instructions. In the case of a method probe or constructor probe, the injector searches for a return instruction. When a return instruction is encountered in the original code, the code is modified to invoke the “Hooks” runtime immediately before the actual return instruction. The entire block of the original code is also wrapped in a try/catch block so that any exceptions thrown by the original code can be caught and forwarded to the “Hooks” runtime before they are actually thrown back to the caller of this method.

Referring to FIG. 12, the second injection mechanism generates modified code that accomplishes the following steps. A call is made to get the “Hooks” singleton in the modified code (step 1202); in the case of a constructor, the initialization happens after either the “super( )” or “this( )” call. A call is also made to initialize a new “InvokedMemberContext” (step 1204) and along with a call to the “Hooks.pre” method (step 1206). The original method body or constructor body is then executed within a try block for which each return statement is prefixed with a call to “Hooks.post” (step 1208). If necessary, a call is made to the “Hooks.postThrown” method in the corresponding catch blocks along with code to re-throw an exception that may have been thrown by the original method (step 1210).

This second injection mechanism is not as fast as the first injection mechanism because it requires scanning part of the method bytecodes, but it produces a more compact class file because it injects the instrumentation in the probed method itself without requiring additional space for an entire new method that calls the original one.

An example is now provided for the injection mechanisms that were described with respect FIGS. 10-12. Table 8 shows the “read” method in the class “SocketInputStream”; this method represents an original, unmodified method.

TABLE 8

public class SocketInputStream {

public int read(byte[] buf, int off, int len) {

... // original “read” method body

}
return handle;

}

While employing the first injection mechanism on the “read” method, the original read method is renamed, e.g., to “original$0$read”, and a new “read” method is added to the “SocketInputStream” class file. Table 9 illustrates the “SocketInputStream” class after the probe injection phase.

TABLE 9
public class SocketInputStream {

```
private int original$0$read(byte[] buf, int off, int len) {
  ... // original read method body
}
public int read(byte[] buf, int off, int len) {
  IHooks hooks = factory.getHooks( ).
  IInvokedMemberContext imc =
```

hooks.createInvokedMemberContext(
com.ibm.net.SocketInputStream.class,
“read”, “([BII)I”, Modifiers.PUBLIC, this,
new Object[] {buf, new Integer(off), new Integer(len)} );

```
  IProbeHandle handle = hooks.pre(imc);
  int returnValue;
  try {
```

returnValue = original$0$read(buf, off, len);

} catch(Throwable t) {

hooks.postThrown(handle, t);
throw t;

```
  }
  hooks.post(handle, new Integer(returnValue));
  return returnValue;
}
```

}

Alternatively, the second injection mechanism could be used on the “read” method that is shown in Table 8. Table 10 illustrates the “SocketInputStream” class after the probe injection phase employs the second injection mechanism on the “read” method, which wraps the original method body with a try block.

TABLE 10

public class SocketInputStream {

public int read(byte[] buf, int off, int len) {

Hooks hooks = factory.getHooks( );
IInvokedMemberContext imc =

hooks.createInvokedMemberContext(
com.ibm.net.SocketInputStream.class,
“read”, “([BII)I”, Modifiers.PUBLIC, this,
new Object[] {
buf, new Integer(off), new Integer(len) } );

ProbeHandle handle = hooks.pre(imc);
try {

... // original read method body
hooks.post(handle, new Integer(returnValue));
return returnValue;

} catch(Throwable t) {

hooks.postThrown(handle, t);
throw t;

}

}

}

Table 11 provides an example of a registration file that may be used for a “TransferRateProbe” probe for the method that is shown in Table 8, i.e. the “read” method in the class “SocketInputStream”.

TABLE 11
<registry xmlns=“http://www.ibm.com/jiti”

xmlns:xsi=“http://www.w3.org/2001/XMLSchema-instance”
xsi:schemaLocation=“http://www.ibm.com/jiti registry.xsd”>

<!-- Define the probed class -->
<class id=“SocketIS”>

name=“java.net.SocketInputStream”/>

<!-- Define the probed method -->
<method id=“ISRead”

name=“read”
parameters=“(byte[ ], int, int)”/>

</method>
<!-- Define the probe -->
<probe id=“TransferRateProbe”

class=“com.ibm.sysmgmt.probe.TransferRateProbe”/>

<!-- Define the location to probe -->
<location id=“SocketISRead”>
<class ref=“SocketIS”/>
<method ref=“ISRead”/>
<type ref=“methodBodyType”/>
</location>
<!-- Define what probe(s) to run against the location. -->
<association id=“SocketISRead_TransferRateProbe”>

<location ref=“SocketISRead”/>
<probe ref=“TransferRateProbe”/>

</association>

</registry>

Table 12 provides an example of some code for the “TransferRateProbe” probe in accordance with Table 11.

TABLE 12
import com.ibm.tivoli.jiti.probe.*;
import com.ibm.tivoli.jiti.probe.scope.*;
public class TransferRateProbe

implements IMethodProbe, IInstanceScope {

/** This is a method probe for calculating the transfer

rate of data read through the “int read(byte[ ] buf, int
off, int len)” method from an “InputStream”.*/

```
private long totalBytes;
private long totalTimeMillis;
/** Called before the execution of a probed method */
public void pre (IMethodProbeContext context) {
// save start time in the context
context.setUserObject(new Long (System.currentTimeMillis( )));
}
/** Called after successful execution of probed method */
public void post (IMethodProbeContext c) {
  // get len parameter from read method
  Integer len = (Integer c.getInvokedMemberContext( )
```

.getProbedReturnValue( );

```
  // update the total number of bytes read on this stream
  totalBytes += len.longValue( );
  // get the correspondent start time saved on the context
  long startTime = ((Long)c.getUserObject( )).longValue( );
  // update the total time spent on the read method
  totalTimeMillis += System. currentTimeMillis( ) - startTime;
}
/** Called after execution of a probed method throwing
```

an exception */

public void postThrown(IMethodProbeContext context) {
}
/** Return the transfer rate in bytes per second */
public long getTransferRate( ) {

return totalBytes * 1000 / totalTimeMillis;

}

}

The advantages of the present invention should be apparent in view of the detailed description of the invention that is provided above. Unlike other prior art solutions that contain a component similar to the injector of the present invention, the injector does not decompile a class file that is to be instrumented, add the special instrumentation code, and then recompile the modified class.

In the present invention, the injector alters the Java methods and constructors specified in the registry by injecting special bytecodes in the class files. Bytecodes are added in such a way that the behavior of the class is not changed. These bytecodes include invocations to hooks methods that contain the logic to manage the execution of the probes. When a hook is executed, it gets the list of probes that are currently enabled for its location from the registry and executes them. Moreover, the present invention provides the ability to dynamically add and/or remove probes and to dynamically enable and/or disable probes at runtime.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for instrumenting a software application, the method comprising:
in response to a portion of the software application being loaded into memory, determining whether the portion of the software application includes a previously specified location to be instrumented;
in response to a determination that the portion of the software application includes the previously specified location, inserting a hook at the previously specified location; and
upon execution of the hook, determining whether a probe that was previously associated with the previously specified location is available for invocation from the hook.

2. The method of claim 1 further comprising:
invoking the probe from the hook.

3. The method of claim 1 further comprising:
in response to a determination that a probe that was previously associated with the previously specified location is available for invocation by the hook, determining whether the probe is enabled; and
in response to a determination that the probe is enabled, invoking the probe from the hook.

4. The method of claim 1 wherein the probe comprises code for managing or monitoring the software application.

5. The method of claim 1 further comprising:
registering at least one probe that is associated with the location such that at least one probe is available when the portion of the software application is loaded.

6. The method of claim 1 wherein the location is method, constructor, field getter/setter function, catch block, throw statement, synchronized block, static initializer, or method invocation.

7. The method of claim 1 wherein the portion of the software application is a Java class file.

8. The method of claim 7 further comprising:
receiving notification of a class load event at an instrumentation injector component from a Java class loader.

9. The method of claim 8 further comprising:
retrieving the previously specified location from a registry by the instrumentation injector component.

10. The method of claim 9 wherein the registry is programmatically updateable.

11. The method of claim 9 further comprising:
retrieving the probe that was previously associated with the previously specified location from the registry by the hook.

12. A computer program product in a computer readable medium for instrumenting a software application in a data processing system, the computer program product comprising:
means for determining whether a portion of the software application includes a previously specified location to be instrumented in response to the portion of the software application being loaded into memory;
means for inserting a hook at the previously specified location in response to a determination that the portion of the software application includes the previously specified location; and
means for determining whether a probe that was previously associated with the previously specified location is available for invocation from the hook upon execution of the hook.

13. The computer program product of claim 12 further comprising:
means for invoking the probe from the hook.

14. The computer program product of claim 12 further comprising:
means for determining whether the probe is enabled in response to a determination that a probe that was previously associated with the previously specified location is available for invocation by the hook; and
means for invoking the probe from the hook in response to a determination that the probe is enabled.

15. The computer program product of claim 12 wherein the probe comprises code for managing or monitoring the software application.

16. The computer program product of claim 12 further comprising:
means for registering at least one probe that is associated with the location such that at least one probe is available when the portion of the software application is loaded.

17. The computer program product of claim 12 wherein the location is method, constructor, field getter/setter function, catch block, throw statement, synchronized block, static initializer, or method invocation.

18. The computer program product of claim 12 wherein the portion of the software application is a Java class file.

19. The computer program product of claim 18 further comprising:
means for receiving notification of a class load event at an instrumentation injector component from a Java class loader.

20. The computer program product of claim 19 further comprising:
means for retrieving the previously specified location from a registry by the instrumentation injector component.

21. The computer program product of claim 20 wherein the registry is programmatically updateable.

22. The computer program product of claim 20 further comprising:
means for retrieving the probe that was previously associated with the previously specified location from the registry by the hook.

23. An apparatus for instrumenting a software application, the apparatus comprising:
means for determining whether a portion of the software application includes a previously specified location to be instrumented in response to the portion of the software application being loaded into memory;
means for inserting a hook at the previously specified location in response to a determination that the portion of the software application includes the previously specified location; and
means for determining whether a probe that was previously associated with the previously specified location is available for invocation from the hook upon execution of the hook.

24. The apparatus of claim 23 further comprising:
means for invoking the probe from the hook.

25. The apparatus of claim 23 further comprising:
means for determining whether the probe is enabled in response to a determination that a probe that was previously associated with the previously specified location is available for invocation by the hook; and
means for invoking the probe from the hook in response to a determination that the probe is enabled.

26. The apparatus of claim 23 wherein the probe comprises code for managing or monitoring the software application.

27. The apparatus of claim 23 further comprising:
means for registering at least one probe that is associated with the location such that at least one probe is available when the portion of the software application is loaded.

28. The apparatus of claim 23 wherein the location is method, constructor, field getter/setter function, catch block, throw statement, synchronized block, static initializer, or method invocation.

29. The apparatus of claim 23 wherein the portion of the software application is a Java class file.

30. The apparatus of claim 29 further comprising:
means for receiving notification of a class load event at an instrumentation injector component from a Java class loader.

31. The apparatus of claim 30 further comprising:
means for retrieving the previously specified location from a registry by the instrumentation injector component.

32. The apparatus of claim 31 wherein the registry is programmatically updateable.

33. The apparatus of claim 31 further comprising:
means for retrieving the probe that was previously associated with the previously specified location from the registry by the hook.
